(19) United States
(12) Patent Application Publication
(10) Pub. No.: US 2005/0267722 A1
(43) Pub. Date: Dec. 1, 2005

(54) Computer-assisted external fixation apparatus and method

(76) Inventors: Joel Marquart, Davie, FL (US); Louis K. Arata, Mentor, OH (US); Randall Hand, Pembroke Pines, FL (US); Arthur E. Quaid III, Hollywood, FL (US); Rony A. Abovitz, Hollywood, FL (US); Scott Illsley, Hollywood, FL (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 11/007,647

(22) Filed: Dec. 6, 2004

Related U.S. Application Data
(63) Continuation of application No. 10/772,142, filed on Feb. 4, 2004.
(60) Provisional application No. 60/444,989, filed on Feb. 4, 2003.
(60) Provisional application No. 60/445,001, filed on Feb. 4, 2003.
(60) Provisional application No. 60/444,824, filed on Feb. 4, 2003.
(60) Provisional application No. 60/444,975, filed on Feb. 4, 2003.
(60) Provisional application No. 60/445,078, filed on Feb. 4, 2003.
(60) Provisional application No. 60/444,988, filed on Feb. 4, 2003.
(60) Provisional application No. 60/445,002, filed on Feb. 4, 2003.
(60) Provisional application No. 60/319,924, filed on Feb. 4, 2003.

(51) Int. Cl. G06G 7/48

(52) U.S. Cl. 703/11

(57) ABSTRACT

A computer-assisted external fixation apparatus and method comprises an external fixation application for assisting, guiding, and planning an external fixation procedure. The external fixation application cooperates with a tracking system to acquire kinematic data corresponding to a selected joint during manipulation of the selected joint and/or acquire image data of patient anatomy and determine a kinematic parameter for the selected joint using the kinematic and/or image data, such as an axis of rotation or plane of movement. The external fixation application may then be used with the tracking system to provide real-time alignment information for alignment of an external fixator based on the information associated with the determined kinematic parameter.

This patent application is a continuation of U.S. patent application Ser. No. 10/772,142, entitled “Computer-Assisted External Fixation Apparatus and Method,” filed Feb. 4, 2004; and claims the benefit of U.S. provisional patent application Ser. No. 60/444,989, entitled “Computer-Assisted External Fixation Apparatus and Method,” filed Feb. 4, 2003, the disclosure of which is incorporated herein by reference. This application relates to the following United States provisional patent applications: Ser. No. 60/444,824, entitled “Interactive Computer-Assisted Surgery System and Method”; Ser. No. 60/444,975, entitled “System and Method for Providing Computer Assistance With Spinal Fixation Procedures”; Ser. No. 60/445,078, entitled “Computer-Assisted Knee Replacement Apparatus and Method”; Ser. No. 60/444,988, entitled “Computer-Assisted Knee Replacement Apparatus and Method”; Ser. No. 60/445,002, entitled “Method and Apparatus for Computer Assistance With Total Hip Replacement Procedure”; Ser. No. 60/445,001, entitled “Method and Apparatus for Computer Assistance With Intramedullary Nail Procedure”; and Ser. No. 60/319,924, entitled “Portable, Low-Profile Integrated Computer, Screen and Keyboard for Computer Surgery Applications”; each of which was filed on Feb. 4, 2003 and is incorporated herein by reference. This application also relates to the following applications: U.S. patent application Ser. No. 10/772,083, entitled “Interactive Computer-Assisted Surgery System and Method”; U.S. patent application Ser. No. 10/771,850, entitled “System and Method for Providing Computer Assistance With Spinal Fixation Procedures”; U.S. patent application Ser. No. 10/772,139, entitled “Computer-Assisted Knee Replacement Apparatus and Method”; U.S. patent application Ser. No. 10/772,085, entitled “Computer-Assisted Knee Replacement Apparatus and Method”; U.S. patent application Ser. No. 10/772,092, entitled “Method and Apparatus for Computer Assistance With Total Hip Replacement Procedure”; U.S. patent application Ser. No. 10/771,851, entitled “Method and Apparatus for Computer Assistance With Intramedullary Nail Procedure”; and U.S. patent application Ser. No. 10/772,137, entitled “Portable Low-Profile Integrated Computer, Screen and Keyboard for Computer Surgery Applications”; each of which was filed on Feb. 4, 2004 and is incorporated herein by reference.

### TECHNICAL FIELD OF THE INVENTION

The present invention relates generally to the field of medical systems and methods and, more particularly, to a computer-assisted external fixation apparatus and method.

### BACKGROUND OF THE INVENTION

Image-based surgical navigation systems display the positions of surgical tools with respect to preoperative (prior to surgery) or intraoperative (during surgery) image datasets. Two and three dimensional image data sets are used, as well as time-variant images data (i.e. multiple data sets take at different times). Types of data sets that are primarily used include two-dimensional fluoroscopic images and three-dimensional data sets include magnetic resonance imaging (MRI) scans, computer tomography (CT) scans, positron emission tomography (PET) scans, and angiographic data. Intraoperative images are typically fluoroscopic, as a C-arm fluoroscope is relatively easily positioned with respect to patient and does not require that a patient be moved. Other types of imaging modalities require extensive patient movement and thus are typically used only for preoperative and post-operative imaging.

The most popular navigation systems make use of a tracking or localizing system to track tools, instruments and patients during surgery. These systems locate in predefined coordinate space specially recognizable markers or elements that are attached or affixed to, or possibly inherently a part of, an object such as an instrument or a patient. The elements can take several forms, including those that can be located using optical (or visual), magnetic, or acoustical methods. Furthermore, at least in the case of optical or visual systems, the location of an object's position may be based on intrinsic features or landmarks that, in effect, function as recognizable elements. The elements will have a known, geometrical arrangement with respect to, typically, an end point and/or axis of the instrument. Thus, objects can be recognized at least in part from the geometry of the elements (assuming that the geometry is unique), and the orientation of the axis and location of endpoint within a frame of reference deduced from the positions of the elements.

A typical optical tracking system functions primarily in the infrared range. They usually include a stationary stereo camera pair that is focused around the area of interest and sensitive to infrared radiation. Elements emit infrared radiation, either actively or passively. An example of an active element is a light emitting diode (LED). An example of a passive element is a reflective element, such as ball-shaped element with a surface that reflects incident infrared radiation. Passive systems require an infrared radiation source to illuminate the area of focus. A magnetic system may have a stationary field generator that emits a magnetic field that is sensed by small coils integrated into the tracked tools.

Most computer-assisted surgery (CAS) systems are capable of continuously tracking, in effect, the position of tools (sometimes also called instruments). With knowledge of the position of the relationship between the tool and the patient and the patient and an image data sets, a system is able to continually superimpose a representation of the tool on the image in the same relationship to the anatomy in the image as the relationship of the actual tool to the patient's anatomy. To obtain these relationships, the coordinate system of the image data set must be registered to the relevant anatomy of the actual patient and portions of the of the patient's anatomy in the coordinate system of the tracking system. There are several known registration methods.

In CAS systems that are capable of using two-dimensional image data sets, multiple images are usually taken from different angles and registered to each other so that a representation of the tool or other object (which can be real or virtual) can be, in effect, projected into each image. As the position of the object changes in three-dimensional space, its projection into each image is simultaneously updated. In order to register two or more two-dimensional data images together, the images are acquired with what is called a registration phantom in the field of view of the image device. In the case of a two-dimensional fluoroscopic images, the phantom is a radio-translucent body holding radio-opaque fiducials having a known geometric relationship. Knowing the actual position of the fiducials in three-dimensional space when each of the images are taken permits determination of a relationship between the position of the fiducials and their respective shadows in each of the images. This relationship can then be used to create a transform for mapping between points in three-dimensional space and each of the images. By knowing the positions of the fiducials with respect to the tracking system's frame of reference, the relative positions of tracked tools with respect to the patient's anatomy can be accurately indicated in each of the images, presuming the patient does not move after the image is acquired, or that the relevant portions of the patient's anatomy are tracked. A more detailed explanation of registration of fluoroscopic images and coordination of representations of objects in patient space superimposed in the images is found in U.S. Pat. No. 6,198,794 of Peshkin, et al., entitled “Apparatus and method for planning a stereotactic surgical procedure using coordinated fluoroscopy.”

### SUMMARY OF THE INVENTION

The invention is generally directed to improved computer-implemented methods and apparatus for further reducing the invasiveness of an external fixation surgical procedures, eliminating or reducing the need for fluoroscopic or other types of subject images during the external fixation procedure, and/or improving the precision and/or consistency of the external fixation procedure. Thus, the invention finds particular advantage in orthopedic external fixation for a variety of external fixation joint applications, though it may also be used in connection with other types of external fixation procedures or as a method for determining the mechanical or kinematic parameters of a joint while manipulating the joint.

In one embodiment, the computer-assisted external fixation system employs an external fixation application that provides a series of images (e.g., graphical representations of a subject joint) and corresponding instructions for performing an external fixation procedure. The external fixation system and method cooperates with a tracking system to acquire static and/or kinematic information for a selected joint to provide increased placement accuracy for the fixation device relative to the joint. For example, according to one embodiment, the external fixation application instructs a user to perform a particular joint manipulation procedure to the selected joint. During manipulation of the joint, the external fixation application cooperates with the tracking system to acquire kinematic data for the joint to determine and identify one or more kinematic parameters of the joint, such as an axis of rotation or plane of movement. The external fixation application may then be used with the tracking system to track the location and orientation of an external fixation device and feedback real-time alignment information of the fixation device with the selected kinematic parameter of the joint to guide its attachment to the subject.

### BRIEF DESCRIPTION OF THE DRAWINGS

For a more complete understanding of the present invention and the advantages thereof, reference is now made to the following descriptions taken in connection with the accompanying drawings in which:

FIG. 1 is a block diagram illustrating an exemplary computer-assisted surgery system;

FIG. 2 is a flow chart of basic steps of an application program for assisting with or guiding the planning of, and navigation during, an external fixation procedure; and

FIGS. 3-8 are representative screen images of graphical user interface pages generated and displayed by the application program of FIG. 2.

### DETAILED DESCRIPTION OF THE DRAWINGS

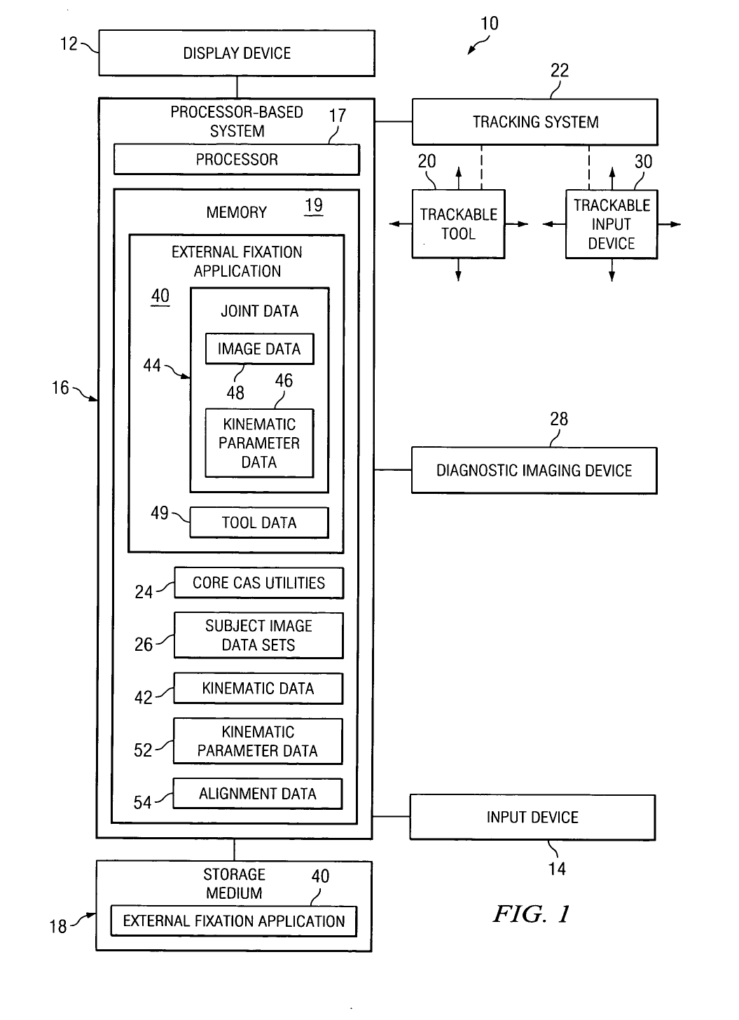

The preferred embodiments of the present invention and the advantages thereof are best understood by referring to FIGS. 1-8 of the drawings, like numerals being used for like and corresponding parts of the various drawings.

FIG. 1 is a block diagram of an exemplary computer-assisted surgery (CAS) system 10. CAS system 10 comprises a display device 12, an input device 14, and a processor-based system 16, for example a computer. Display device 12 may be any display device now known or later developed for displaying two-dimensional and/or three-dimensional diagnostic images, for example, a monitor, a touch screen, a wearable display, a projection display, a head-mounted display, stereoscopic views, a holographic display, a display device capable of displaying image(s) projected from an image projecting device, for example a projector, and/or the like. Input device 14 may be any input device now known or later developed, for example, a keyboard, a mouse, a trackball, a trackable probe, and/or the like. The processor-based system 16 is preferably programmable and includes one or more processors 17, working memory 19 for temporary program and data storage that will be used primarily by the processor, and storage for programs and data, preferably persistent, such as a disk drive. Removable media storage medium 18 can also be used to store programs and/or data transferred to or from the processor-based system 16. The storage medium 18 may include a floppy disk, an optical disc, or any other type of storage medium now known or later developed.

Tracking system 22 continuously determines, or tracks, the position of one or more trackable elements disposed on, incorporated into, or inherently a part of surgical instruments or tools 20 with respect to a three-dimensional coordinate frame of reference. With information from the tracking system 22 on the location of the trackable elements, CAS system 10 is programmed to be able to determine the three-dimensional coordinates of an endpoint or tip of a tool 20 and, optionally, its primary axis using predefined or known (e.g. from calibration) geometrical relationships between trackable elements on the tool and the endpoint and/or axis of the tool 20. A patient, or portions of the patient's anatomy, can also be tracked by attachment of arrays of trackable elements.

The CAS system 10 can be used for both planning surgical procedures (including planning during surgery) and for navigation. It is therefore preferably programmed with software for providing basic image guided surgery functions, including those necessary for determining the position of the tip and axis of instruments and for registering a patient and preoperative and/or intraoperative diagnostic image data sets to the coordinate system of the tracking system. The programmed instructions for these functions are indicated as core CAS utilities 24. These capabilities allow the relationship of a tracked instrument to a patient to be displayed and constantly updated in real time by the CAS system 10 overlaying a representation of the tracked instrument on one or more graphical images of the patient's anatomy on display device 12. The graphical images may be a virtual representation of the patient's anatomy or may be constructed from one or more stored image data sets 26 acquired from a diagnostic imaging device 28. The imaging device may be a fluoroscope, such as a C-arm fluoroscope, capable of being positioned around a patient laying on an operating table. It may also be a MR, CT or other type of imaging device in the room or permanently located elsewhere. Where more than one image is shown, as when multiple fluoroscopic images are simultaneously displayed of display device 12, the representation of the tracked instrument or tool is coordinated between the different images. However, CAS system 10 can be used in some procedures without the diagnostic image data sets, with only the patient being registered. Thus, the CAS system 10 may need not to support the use diagnostic images in some applications—i.e., an imageless application.

Furthermore, as disclosed herein, the CAS system 10 may be used to run application-specific programs that are directed to assisting a surgeon with planning and/or navigation during specific types of procedures. For example, the application programs may display predefined pages or images corresponding to specific steps or stages of a surgical procedure. At a particular stage or part of a program, a surgeon may be automatically prompted to perform certain tasks or to define or enter specific data that will permit, for example, the program to determine and display appropriate placement and alignment of instrumentation or implants or provide feedback to the surgeon. Other pages may be set up to display diagnostic images for navigation and to provide certain data that is calculated by the system for feedback to the surgeon. Instead of or in addition to using visual means, the CAS system 10 could also communicate information in ways, including using audibly (e.g. using voice synthesis) and tactilely, such as by using a haptic interface type of device. For example, in addition to indicating visually a trajectory for a drill or saw on the screen, the CAS system 10 may feedback to a surgeon information whether he is nearing some object or is on course with a audible sound or by application of a force or other tactile sensation to the surgeon's hand.

To further reduce the burden on the surgeon, the program may automatically detect the stage of the procedure by recognizing the instrument picked up by a surgeon and move immediately to the part of the program in which that tool is used. Application data generated or used by the application may also be stored in processor-based system 16.

Various types of user input methods can be used to improve ease of use of the CAS system 10 during surgery. One example is the use the use of speech recognition to permit a doctor to speak a command. Another example is the use of a tracked object to sense a gesture by a surgeon, which is interpreted as an input to the CAS system 10. The meaning of the gesture could further depend on the state of the CAS system 10 or the current step in an application process executing on the CAS system 10. Again, as an example, a gesture may instruct the CAS system 10 to capture the current position of the object. One way of detecting a gesture is to occlude temporarily one or more of the trackable elements on the tracked object (e.g. a probe) for a period of time, causing loss of the CAS system's 10 ability to track the object. A temporary visual occlusion of a certain length (or within a certain range of time), coupled with the tracked object being in the same position before the occlusion and after the occlusion, would be interpreted as an input gesture. A visual or audible indicator that a gesture has been recognized could be used to provide feedback to the surgeon.

Yet another example of such an input method is the use of tracking system 22 in combination with one or more trackable data input devices 30. Defined with respect to the trackable input device 30 are one or more defined input areas, which can be two-dimensional or three-dimensional. These defined input areas are visually indicated on the trackable input device 30 so that a surgeon can see them. For example, the input areas may be visually defined on an object by representations of buttons, numbers, letters, words, slides and/or other conventional input devices. The geometric relationship between each defined input area and the trackable input device 30 is known and stored in processor-based system 16. Thus, the processor 17 can determine when another trackable object touches or is in close proximity a defined input area and recognize it as an indication of a user input to the processor based system 16. For example, when a tip of a tracked pointer is brought into close proximity to one of the defined input areas, the processor-based system 16 will recognize the tool near the defined input area and treat it as a user input associated with that defined input area. Preferably, representations on the trackable user input correspond user input selections (e.g. buttons) on a graphical user interface on display device 12. The trackable input device 30 may be formed on the surface of any type of trackable device, including devices used for other purposes. In a preferred embodiment, representations of user input functions for graphical user interface are visually defined on a rear, flat surface of a base of a tool calibrator.

Processor-based system 16 is, in one example, a programmable computer that is programmed to execute only when single-use or multiple-use software is loaded from, for example, removable media 18. The software would include, for example the application program for use with a specific type of procedure. The application program can be sold bundled with disposable instruments specifically intended for the procedure. The application program would be loaded into the processor-based system 16 and stored there for use during one (or a defined number) of procedures before being disabled. Thus, the application program need not be distributed with the CAS system 10. Furthermore, application programs can be designed to work with specific tools and implants and distributed with those tools and implants. Preferably, also, the most current core CAS utilities 24 may also be stored with the application program. If the core CAS utilities 24 on the processor-based system 16 are outdated, they can be replaced with the most current utilities.

In FIG. 1, the application program comprises an external fixation application 40 for assisting with, planning, and guiding an external fixation procedure. The external fixation application 40 provides a series of graphical interface pages and corresponding instructions or guidelines for performing the external fixation procedure. The external fixation application 40 may be loaded into the processor-based system 16 from the media storage device 18. Processor-based system 16 may then execute the external fixation application 40 solely from memory 19 or portions of the application 40 may be accessed and executed from both memory 19 and the storage medium 18. The external fixation application 40 may be configured having instructions and displayable images for assisting, planning, and guiding an external fixation procedure for a single joint or multiple joints such as, but not limited to, wrist, elbow, knee, ankle, or any other joint requiring external fixation.

In operation, trackable elements are coupled to or affixed to portions of the subject corresponding to the particular joint receiving external fixation. For example, in an elbow joint external fixation procedure, trackable elements may be coupled to the humerus and the radius or ulna of the subject such that movement of the humerus and/or ulna of the subject relative to each other correlates to a particular kinematic parameter of the subject which, in this example, would be an axis of rotation of the elbow joint. In one embodiment, the trackable elements may comprise an array of trackable elements having a predetermined geometrical configuration relative to each other such that tracking system 22 identifies the geometrical configuration of the trackable elements and correlates the array of to a particular location of the subject, such as either the humerus or the ulna.

The external fixation application 40 cooperates with the tracking system 22 to acquire kinematic data 42, which may be stored in memory 19, corresponding to movement or use of a selected joint and automatically determines a kinematic parameter of the joint using the acquired kinematic data 42. For example, in an elbow external fixation procedure, trackable element arrays are coupled to the humerus and the ulna of the subject. The external fixation application 40 then instructs or requests manipulation of the subject corresponding to the particular joint. During manipulation of the joint, tracking system 22 acquires kinematic data 42 by tracking the trackable element arrays coupled to the subject. From the acquired kinematic data 42, the external fixation application then determines or computes a kinematic parameter for the joint using the acquired kinematic data 42. For example, in an external fixation elbow procedure, tracking system 22 acquires kinematic data 42 reflecting movement of the ulna and/or humerus relative to each other. From the acquired kinematic data 42, the external fixation application 40 may then determine a kinematic parameter, such as the axis of rotation of the elbow joint. The determined kinematic parameter may then be displayed on display device 12.

After external fixation application 40 identifies and determines a particular kinematic parameter corresponding to the selected joint, the external fixation application 40 then cooperates with tracking system 22 to provide alignment of an external fixation device with the determined and displayed kinematic parameter. For example, a trackable element array may be secured to the external fixation device or a trackable tool 20 may be used in connection with the external fixation device to accurately locate the external fixation device relative to the joint. For example, in operation, the external fixation application 40 cooperates with the tracking system 22 to track the location of the external fixation device relative to the subject to align the external fixation device with the determined kinematic parameter of the joint. Thus, in an elbow external fixation procedure, the external fixation application 40 cooperates with the tracking system 22 to align the external fixation device with the determined axis of rotation of the elbow. The external fixation application 40 may also be configured to alert or otherwise generate a signal indicating alignment of the external fixation device with the determined or selected kinematic parameter.

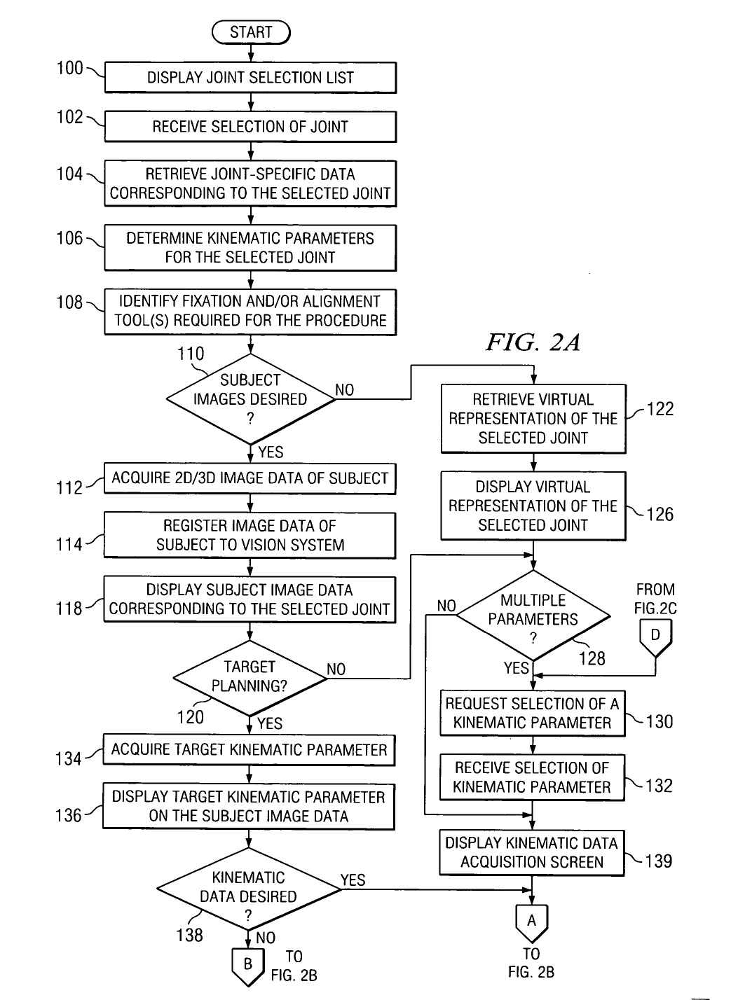

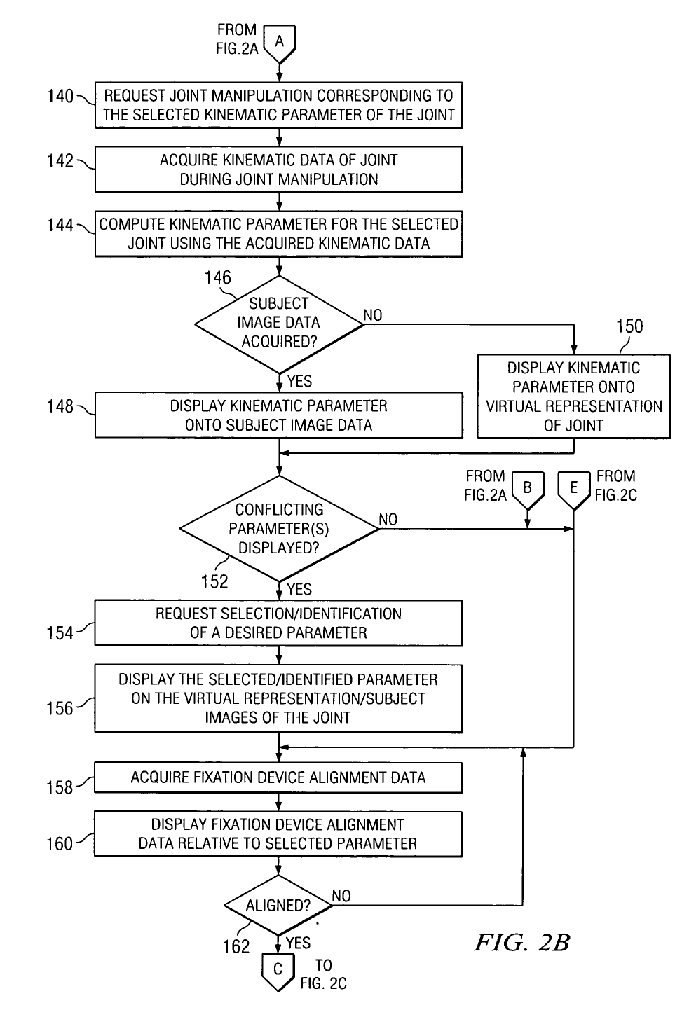

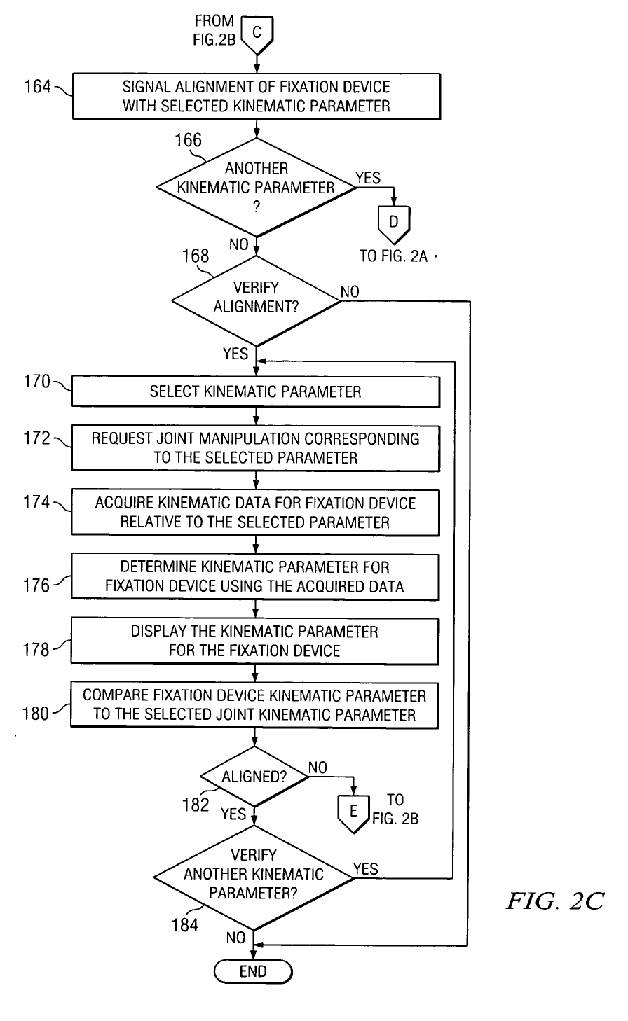

FIG. 2 is a flowchart illustrating an embodiment of an external fixation application method in accordance with the present invention. The method begins at step 100, where the external fixation application 40 displays on display device 12 a joint selection list. For example, the external fixation application 40 may comprise joint data 44 having information associated with multiple joints for which the application 40 may be used. Thus, in response to a selection of a particular joint, the application 40 provides instructions and corresponding graphical interface pages and/or displayable images for the selected joint. At step 102, the external fixation application 40 receives a selection of a particular joint. For example, the display device 12 may be adapted with a touch screen for receiving joint selection input, the user may select the desired joint using input device 14, the selection may be made by audible commands issued by the user, or the user may otherwise provide joint selection input to processor-based system 18.

In response to receiving a joint selection input, the external fixation application 40 retrieves joint-specific information corresponding to the selected joint, such as kinematic parameter data 46 having information associated with the kinematic parameters corresponding to the selected joint and image data 48 having image information for displaying a virtual representation of the selected joint on display device 12. At step 106, the external fixation application 40 determines the kinematic parameters for the selected joint using the kinematic parameter data 46. For example, if the selected joint is an elbow joint, the kinematic parameter may comprise an axis of rotation of the ulna relative to the humerus. However, for other joints, single or multiple kinematic parameters may be determined.

At step 108, external fixation application 40 may be configured to retrieve tool data 49 to identify the particular external fixation devices and/or trackable alignment tools 20 required for the external fixation procedure. For example, the external fixation application 40 may identify a particular external fixation device corresponding to the selected joint and/or a particular trackable tool 20 to be used in connection with the external fixation device for aligning the external fixation device with a particular kinematic parameter of the selected joint. At decisional step 110, the external fixation application 40 requests whether the user would desire to use subject images for the procedure. If subject images are desired, the method proceeds from step 110 to step 112, where processor-based system 16 acquires or retrieves two-dimensional and/or three-dimensional subject image data 26. For example, as described above, fluoroscopic images, magnetic resonance images, or other type of images two-dimensional and/or three-dimensional image data 26 may be retrieved or acquired corresponding to the subject. The image data 26 may be acquired and/or retrieved preoperatively or intraoperatively. The image data 26 may also comprise a time component or dimension to reflect changes in the physical structure associated with the subject over time. At step 114, tracking system 22 registers the image data 26 of the subject with the reference frame of the subject. For example, tracking system 22 registers the subject image data 26 to the subject reference frame using trackable element arrays coupled to the subject or otherwise located within the subject reference frame. Additionally, as a setup procedure, calibration and/or other types of image-correction procedures, such as those associated with dewarping fluoroscopic images, may be performed.

At step 118, the external fixation application 40 displays the subject image data 26 corresponding to the selected joint on display device 12. At decisional step 120, the external fixation application 40 requests whether the user desires to plan or target a particular kinematic parameter based on the subject image data 26. For example, based on subject image data 26 displayed on display device 12, the user may identify bone structures or other characteristics of the subject, and the user may desire to identify or otherwise indicate a target kinematic parameter to be used for alignment of the external fixation device. If target planning of a particular kinematic parameter is desired, the method proceeds from step 120 to step 134. If target planning of a particular kinematic parameter is not desired, the method proceeds from step 120 to decisional step 128.

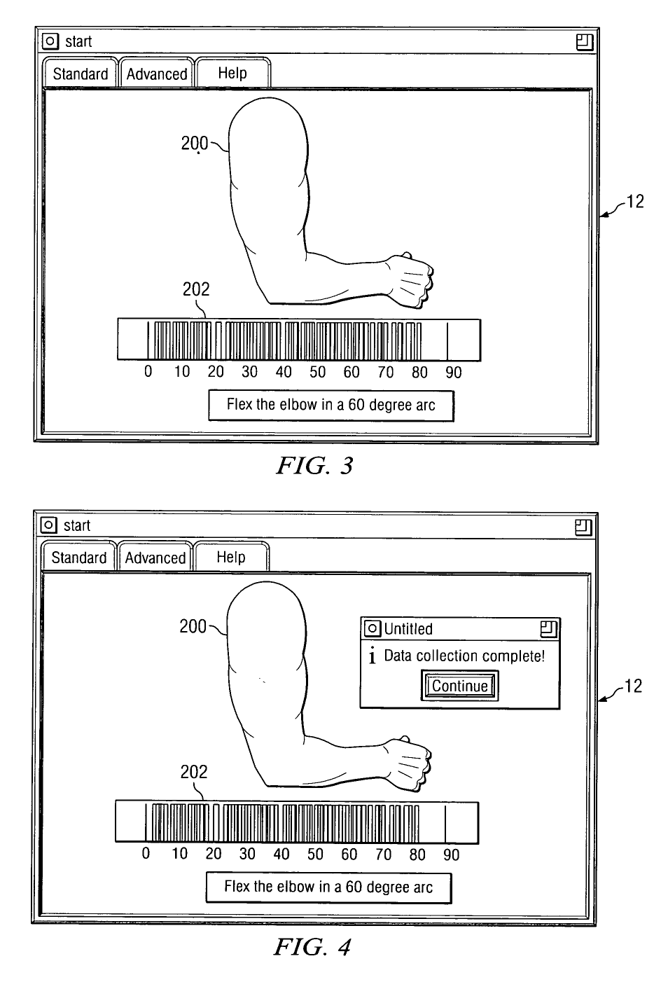

At decisional step 110, if subject image data 26 is not desired, the method proceeds from step 110 to step 122, where external fixation application 40 retrieves image data 48 associated with a virtual representation of the selected joint. For example, preferably, system 10 and external fixation application 40 provide a subject-imageless external fixation procedure to reduce or eliminate the need for fluoroscopic or other types of subject image data for the procedure. At step 126, the external fixation application 40 displays the virtual representation 200 of the selected joint on display device 12, as illustrated in FIG. 3.

At decisional block 128, the external fixation application 40 determines whether multiple kinematic parameters exist for the selected joint. For example, a wrist joint, an ankle joint, and other joints may provide multiple degrees of freedom of movement such that multiple kinematic parameters may be associated with the joint. If multiple kinematic parameters exists for the selected joint, the method proceeds from step 128 to step 130, where external fixation application 40 requests selection of a particular kinematic parameter for this phase or stage of the external fixation procedure. At step 132, the external fixation application 40 receives a selection of a particular kinematic parameter, and then the method proceeds to step 140.

At decisional step 120, if target planning is desired corresponding to a particular kinematic parameter, the method proceeds from step 120 to step 134, where external fixation application 40 acquires the target kinematic parameter from the user. For example, a trackable tool 20 may be used to locate and identify an axis of rotation or other type of kinematic parameter corresponding to the selected joint using tracking system 22. At step 136, external fixation application 40 displays the target kinematic parameter on display device 12 relative to the subject images. At decisional step 138, a determination is made whether kinematic data 42 acquisition is desired. For example, if the user does not desire to use kinematic data 42 corresponding to the selected joint, the user may proceed to step 158, where the user may use tracking system 22 to align the fixation device with the target kinematic parameter. If kinematic data 42 is desired, the method proceeds from step 138 to step 140.

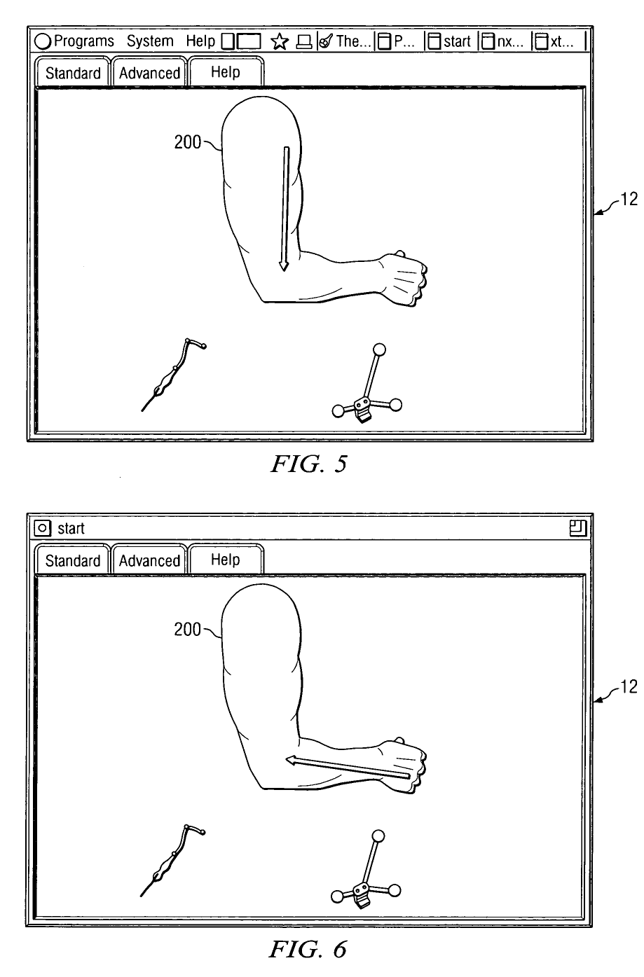

At step 128, if multiple parameters do not exist for the selected joint, the method proceeds to step 139, where the external fixation application 40 displays a kinematic data acquisition indicator 202 on display device 12 as illustrated in FIGS. 3 and 4. At step 140, the external fixation application 40 requests joint manipulation corresponding to the selected kinematic parameter of the joint. For example, in an elbow external fixation procedure, the external fixation application 40 requests flexion and/or extension of the ulna relative to the humerus. Additionally, output of external fixation application 40 to the user in connection with performing the external fixation procedure may be in the form of audible signals, visible signals, or haptic signals. For example, as described above, requests or instructions may be provided to the user audibly via an audio component coupled to system 10 or visibly, such as by display device 12. Additionally, external fixation application 40 may also provide the user with haptic feedback, such as haptically indicating alignment of a trackable tool 20 with a target alignment/orientation point. At step 142, the external fixation application 40 cooperates with the tracking system 22 to acquire kinematic data 42 of the selected joint during joint manipulation. For example, in the elbow external fixation example, trackable element arrays coupled to the humerus and the ulna may be tracked during manipulation of the ulna to provide kinematic movement of the ulna relative to the humerus. Preferably, the kinematic data 42 comprises multiple data points acquired at various kinematic positions of the joint to provide a generally uniform distribution of data points over the range of kinematic motion. Thus, during joint manipulation, the external fixation application 40 may be configured to acquire a predetermined quantity of data points over a predetermined range of kinematic movement of the joint. At step 144, the external fixation application 40 computes or determines kinematic parameter data 52 identifying a particular parameter for the selected joint using the acquired kinematic data 42. For example, in operation, the external fixation application 40 may employ an algorithm corresponding to the anatomy or joint of the subject corresponding to the desired kinematic parameter. Thus, in the elbow external fixation example, the external fixation application 40 determines an axis of rotation of the ulna relative to the humerus. FIGS. 5 and 6 illustrate a determination of the angle of rotation kinematic parameter for the subject elbow joint. However, it should also be understood that fluoroscopic navigation may also be used to determine an axis of rotation for a desired joint.

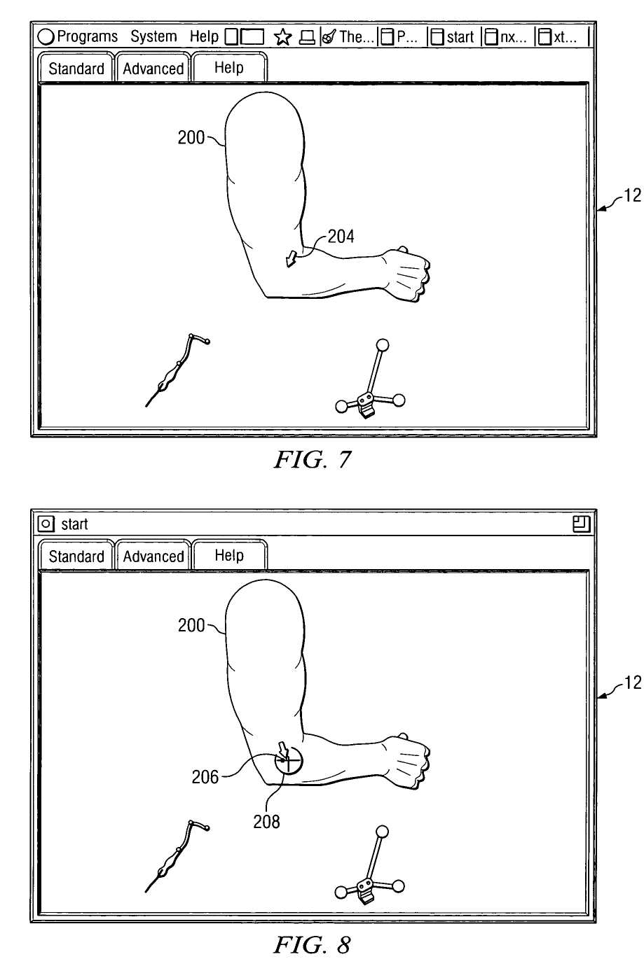

At decisional step 146, a determination is made whether subject image data 26 was previously acquired. If subject image data 26 was previously acquired, the method proceeds from step 146 to step 148, where the external fixation application 40 displays the determined kinematic parameter onto the subject images via display device 12. If subject image data 26 was not previously acquired, the method proceeds from step 146 to step 150, where the external fixation application 40 displays the determined kinematic parameter onto the virtual representation 200 of the selected joint displayed on display device 12. FIG. 7 illustrates the location of the angle of rotation, indicated generally by 204, kinematic parameter for the subject elbow joint relative to the displayed virtual representation 200 of the elbow joint.

At step 152, the external fixation application 40 determines whether conflicting or multiple kinematic parameters exist or are displayed on display device 12 for the selected joint. For example, as described above, the user may have designated a target kinematic parameter based on the location of physical bone structure of the subject based on the subject image data 26. The target kinematic parameter as selected or identified by the user may vary relative to the kinematic parameter determined based on kinematic data 42 acquired during joint manipulation. Additionally, if the joint experiences unusual movement during joint manipulation, which may occur in an injured joint or in response to other irregularities present within the selected joint of the subject, varying kinematic parameters may be displayed or determined by application 40. Thus, if conflicting or multiple kinematic parameters for the joint are determined and/or displayed on display device 12, the method proceeds from step 152 to step 154, where the external fixation application 40 requests the selection or identification of a desired kinematic parameter from the user. At step 156, the external fixation application displays the selected or identified kinematic parameter on either the virtual representation of the subject or the actual subject image data of the joint via display device 12. The method then proceeds to step 158. If conflicting or multiple kinematic parameters are not identified, the method proceeds from step 152 to step 158.

After determination of a particular kinematic parameter for the selected joint, the user may then proceed to locate the external fixation device relative to the joint. In operation, the external fixation application 40 then provides real-time monitoring of the fixation device relative to the joint to align the kinematic parameter of the fixation device with the determined kinematic parameter for the selected joint. For example, pins or other mounting structure may be coupled to the subject corresponding to the selected joint, or may have been previously attached to the subject, for attachment of the external fixation device to the subject relative to the selected joint. As described above, the external fixation device may comprise an array of trackable elements calibrated or registered with the tracking system 22 such that tracking system 22 will recognize and track the external fixation device upon entering an input field of the tracking system 22. Alternatively, a trackable tool 20 may be used in connection with the external fixation device such that position and orientation of the external fixation device may be obtained by tracking the trackable tool 20. For example, in an elbow external fixation procedure, the external fixation device for the elbow may comprise an aperture, mounting hole, or other type of structure for receiving a trackable tool 20, such as a trackable probe, such that the position and location of the trackable tool 20 corresponds to a position and orientation of the external fixation device. Thus, at step 158, the external fixation application 40 cooperates with the tracking system 22 to acquire fixation device alignment data 54 using either a trackable array coupled to the external fixation device or a trackable tool 20 used in connection with the external fixation device.

At step 160, the external fixation application 40 displays the fixation device alignment data 54 relative to the joint kinematic parameter on display device 12, as best illustrated in FIG. 8. For example, in an elbow fixation procedure as illustrated in FIG. 8, the external fixation application 40 displays a representation or indication of the axis of rotation of the elbow joint as acquired during manipulation of the elbow joint, indicated by 206, and an axis of rotation as defined by the external fixation device, indicated by 208. At decisional step 162, the external fixation application 40 monitors the alignment of the kinematic parameter of the fixation device with the determined kinematic parameter for the selected joint. If the parameters are not aligned, the method returns to step 158. If the parameters are aligned, the method proceeds to step 164, where the external fixation application 40 signals alignment of the external fixation device kinematic parameter with the determined kinematic parameter for the selected joint. For example, the signal may comprise a visual indication displayed on display device 12, an audible signal output by processor-based system 16, or any other type of signal for alerting a user of the alignment.

At decisional step 166, the external fixation application 40 determines whether another kinematic parameter exists for the selected joint. For example, as described above, various joints may have multiple degrees of freedom of movement, thereby producing various methods or procedures for an external fixation of the particular joint. If another kinematic parameter exists for the selected joint, the method returns to step 130. If another kinematic parameter does not exists for the selected joint, the method proceeds to step 168, where a determination is made whether the user desires to verify alignment of the external fixation device with the determined kinematic parameter for the selected joint.

If alignment verification is desired, the method proceeds to step 170, where the user selects the desired kinematic parameter. At step 172, based on the selected kinematic parameter, the external fixation application 40 requests joint manipulation corresponding to the selected parameter. At step 174, the external fixation application cooperates with the tracking system 22 to acquire kinematic data 42 for the external fixation device relative to the selected kinematic parameter. For example, the external fixation application 40 and tracking system 22 may track a trackable element array coupled to the fixation device or otherwise used in connection with the external fixation device. At step 176, the external fixation application 40 determines the kinematic parameter for the external fixation device using the acquired kinematic data 42 during manipulation of the fixation device. At step 178, the external fixation application 40 displays the kinematic parameter for the external fixation device on display device 12. At step 180, the external fixation application 40 compares the fixation device kinematic parameter to the previously determined joint kinematic parameter. At decisional step 182, the external fixation application 40 determines whether the fixation device kinematic parameter is aligned with the previously determined kinematic parameter. If the parameters are not aligned, the method returns to step 158. If the parameters are aligned, the method proceeds to decisional step 184, where the external fixation application 40 determines whether another kinematic parameter requires verification. If another kinematic parameter requires verification, the method returns to step 170. If another kinematic parameter does not require verification, the method is completed.

1. A computer-assisted external fixation apparatus, comprising:
a storage medium for storing an external fixation application which, when executed by a processor, displays a series of interface images for assisting a user with an external fixation procedure.

2. The apparatus of claim 1, wherein the external fixation application is adapted to cooperate with a tracking system to acquire kinematic data of a subject joint and determine a kinematic parameter associated with the subject joint.

3. The apparatus of claim 1, wherein the external fixation application is adapted to display a virtual representation of a joint for performing the external fixation procedure.

4. The apparatus of claim 1, wherein the external fixation application is adapted to identify a kinematic parameter for a particular joint in response to a selection of the particular joint by a user.

5. The apparatus of claim 1, wherein the external fixation application is adapted to cooperate with a tracking system to provide real-time alignment data for aligning a fixation device with a determined kinematic parameter of a subject joint.

6. The apparatus of claim 1, wherein the external fixation application is adapted to determine a kinematic manipulation requirement for a joint in response to a selection of the joint by a user to receive the external fixation procedure.

7. The apparatus of claim 1, wherein the external fixation application is adapted to display a virtual representation of a subject joint in response to a selection of the joint by a user to receive the external fixation procedure.

8. The apparatus of claim 1, wherein the external fixation application is adapted to cooperate with a tracking system to display, in real time, a kinematic parameter of a fixation device relative to a subject joint.

9. The apparatus of claim 1, wherein the external fixation application is adapted to display subject image data corresponding to a joint to receive the external fixation procedure.

10. The apparatus of claim 1, wherein the external fixation application is adapted to cooperate with a tracking system to receive a target kinematic parameter for a subject joint based on subject image data of the subject joint.

11. The apparatus of claim 10, wherein the external fixation application is adapted to display alignment data of the target kinematic parameter relative to a kinematic parameter based on physical manipulation of the subject joint.

12. The apparatus of claim 1, wherein the external fixation application is adapted to cooperate with a tracking system to acquire a plurality of kinematic data points over a range of kinematic movement associated with a subject joint.

13. A computer-assisted surgery system, comprising:
a display device; and
an external fixation application executable by a processor and adapted to display a series of interface images on the display device for assisting a user to perform an external fixation procedure.

14. The system of claim 13, wherein the external fixation application is adapted to display a virtual representation of a joint to receive the external fixation procedure on the display device.

15. The system of claim 13, wherein external fixation application is adapted to cooperate with a tracking system to acquire kinematic data associated with movement of a subject joint and determine a kinematic parameter for the subject joint using the kinematic data.

16. The system of claim 15, wherein the external fixation application is adapted to display the determined kinematic parameter on the display device.

17. The system of claim 13, wherein the external fixation application is adapted to cooperate with a tracking system to provide real-time alignment data of a kinematic parameter of a fixation device relative to a kinematic parameter of a subject joint.

18. The system of claim 13, wherein the external fixation application is adapted to list a plurality of different joints to the user for selection of one of the listed joints by the user to receive the external fixation procedure.

19. The system of claim 18, wherein the external fixation application is adapted to identify at least one kinematic parameter for the joint selected by the user.

20. The system of claim 13, wherein the external fixation application is adapted to cooperate with a tracking system to receive a target kinematic parameter for a subject joint based on subject image data of the subject joint.

21. The system of claim 20, wherein the external fixation application is adapted to display alignment data of the target kinematic parameter relative to a kinematic parameter based on physical manipulation of the subject joint.
